(19) United States
(12) Patent Application Publication
(10) Pub. No.: US 2013/0228707 A1
(43) Pub. Date: Sep. 5, 2013

(54) SYSTEM, METHOD & DEVICE FOR UV CURING

(71) Applicant: Kari Nieminen, Braselton, GA (US)

(72) Inventor: Kari Nieminen, Braselton, GA (US)

(21) Appl. No.: 13/409,787

(22) Filed: Mar. 1, 2012

(51) Int. Cl. B01J 19/12

(52) U.S. Cl. 250/492.1

(57) ABSTRACT

A system, method and devices for providing improved methods to harden UV-curable coating materials when those coating materials are applied over optical fibers or other optical targets during the manufacturing process is provided. The technology disclosed herein uses LEDs (or low power light bulbs) to create UV power, which is focused with high intensity on the surface of a coated fiber. This is done simultaneously from multiple angles to fully cover the target product over 360 degrees of surface and is then repeated a number of times along the product path to ensure sufficient degree of curing.

### FIELD OF THE INVENTION

The technology described herein relates generally to a system, method and devices for an improved way to harden UV-curable coating materials that have been applied to optical fibers.

### BACKGROUND OF THE INVENTION

Fiber optic coatings are applied using one of two methods: wet-on-dry and wet-on-wet.

In wet-on-dry, the fiber passes first through a primary coating application, which is then UV cured, then passes through a secondary coating application, which is subsequently cured.

In wet-on-wet, the fiber passes through both the primary and secondary coating applications, then the fiber proceeds to UV curing.

Fiber optic coatings are applied in concentric layers to prevent damage to the fiber during the drawing application and to maximize fiber strength and microbend resistance. Unevenly coated fiber will experience non-uniform forces when the coating expands or contracts, and is susceptible to greater signal attenuation. Under proper drawing and coating processes, the coatings are concentric around the fiber, continuous over the length of the application and have constant thickness.

Fiber optic coatings protect the glass fibers from scratches that could lead to strength degradation. The combination of moisture and scratches accelerates the aging and deterioration of fiber strength. When fiber is subjected to low stresses over a long period, fiber fatigue can occur. Over time or in extreme conditions, these factors combine to cause microscopic flaws in the glass fiber to propagate, which can ultimately result in fiber failure.

Ultraviolet (UV) light is used in the manufacturing process for optical fiber. The UV curing process is used to form a polymer layer that is applied to provide protection, flexibility and strength to the fiber.

UV curable inks are applied to the finished fibers for color coding and identification purposes. The UV-curing process provides instant curing, resulting in optimized production speeds. The finished colors are not susceptible to degradation from the cabling gels used to manufacture multi-fiber cables. For cable manufacturing, UV inks also offer superior abrasion resistance.

Ultraviolet curing (commonly known as UV curing) is a photochemical process in which high-intensity ultraviolet light is used to instantly cure or “dry” inks, coatings or adhesives. Offering many advantages over traditional drying methods, UV curing has been shown to increase production speed, reduce reject rates, improve scratch and solvent resistance, and facilitate superior bonding.

Since it was originally introduced in the 1960's, UV curing has been widely adopted in many industries including automotive, telecommunications, electronics, graphic arts, converting and metal, glass and plastic decorating. UV curing is a multi-billion dollar worldwide industry, and now constitutes approximately 4% of the industrial coatings market. UV curing has grown more than 10% per year, displacing conventional water and solvent-based thermal drying processes due to its increased productivity, improvement of product quality and performance, and environmentally friendly characteristics.

Using light instead of heat, the UV curing process is based on a photochemical reaction. Liquid monomers and oligomers are mixed with a small percent of photo initiators, and then exposed to UV energy. In a few seconds, the products—inks, coatings or adhesives instantly harden.

UV curable inks and coatings were first used as a better alternative to solvent-based products. Conventional heat- and air-drying works by solvent evaporation. This process shrinks the initial application of coatings by more than 50% and creates environmental pollutants. In UV curing, there is no solvent to evaporate, no environmental pollutants, no loss of coating thickness, and no loss of volume. This results in higher productivity in less time, with a reduction in waste, energy use and pollutant emissions.

The reasons for considering UV usually include a number of improved physical properties such as improved gloss, better scratch and abrasion resistance, better chemical resistance, resistance to crazing, hardness, elasticity, adhesion, or bond strength. While these technical features can be measured precisely, determining their actual economic value is usually based on superior product performance which may result in increased market share or increased sales.

Any process requiring less space, allowing higher production speeds, involving less direct labor, makes those facilities and resources available for higher production capacity. Less down time and higher throughput increase machine utilization, and have a direct effect on plant capacity. In general, UV curing offers increased productivity and better plant and equipment utilization.

However current systems are using special bulbs that are very inefficient in producing the necessary UV power.

Additionally, current systems are using elliptical reflectors to collect and focus UV power from the light bulb on the fiber. These reflectors are located a relatively far distance (inches) from the fiber compared to the fiber diameter (0.25 mm typical). Furthermore, the thin metallic reflectors used are subject to high temperature (which may cause shape change due to expansion) during a run and are subject to surface damages during setup and maintenance.

The high heat and ozone generation also requires high volume cooling air flow through the lamp, which results in higher operating cost and a complex design and high space requirements.

Finally, current systems require the entire fiber path through the system to be enclosed inside of a transparent quartz tube, both to provide mechanical protection against the forceful cooling air flow and also to provide the volume around the fiber for pure nitrogen since oxygen inhibits the curing.

The problem with quartz tubes is the loss of light when it passes thru the wall of the tube. This gets more apparent because and when, due to heat and IR radiation, coating materials release smoke vapors that eventually reduce the transparency of the tube walls to a point that no sufficient amount of UV power could be passed without replacement/cleaning of the tubes.

This leads to other problems, notably: quartz tubes are filled with high purity nitrogen (N2) to prevent any oxygen to inhibit curing. So, in order to keep the quartz tube clean, the N2 has to be continuously replaced with clean gas.

Accordingly, there has been a need for improvements in the UV curing process and those improvements have been met by the technology described herein.

Related patents and published patent applications known in the background art include the following, which are incorporated herein in their entirety.

U.S. Pat. No. 7,202,490, issued to Aguirre et al on Apr. 10, 2007, discloses a radiation modifying apparatus comprises a plurality of solid state radiation sources to generate radiation that modifies a first material such as by curing or creating alignment through polarization. The solid state radiation sources can be disposed in an array pattern. Optical concentrators, arranged in a corresponding array pattern, receive radiation from corresponding solid state radiation sources. The concentrated radiation is received by a plurality of optical waveguides, also arranged in a corresponding array pattern. Each optical waveguide includes a first end to receive the radiation and a second end to output the radiation. The radiation modifying apparatus can be utilized for continuous substrate, sheet, piece part, spot curing, and/or 3D radiation-cure processes.

The foregoing patent information reflects the state of the art of which the inventor is aware and is tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

The technology described herein pertains to improved methods to harden UV-curable coating materials when those coating materials are applied over optical fibers or other optical targets during the manufacturing process, e.g. a fiber with wet coating runs through a curing chamber, where coating is exposed to UV light causing coating to cure.

The technology disclosed herein uses LEDs (or low power light bulbs) to create UV power, which is focused with high intensity on the surface of a coated product, e.g. a single optical fiber, an arrangement of multiple coated optical fibers. This is done simultaneously from multiple angles to fully cover the target product over 360 degrees of surface and is then repeated a number of times along the product path to ensure sufficient degree of curing.

In a first exemplary embodiment the technology described herein comprises:
an electrical control unit that feeds electrical power to light sources; conducts on/off control; regulates output power; monitors operation etc.;
a UV curing chamber body which is connected to the electrical control unit through signal and power wiring; the chamber body provides an open path for the product run through as well as housing for number of LED light sources that are arranged to provide even curing around the product; the chamber body has also ports and controls for an N2 atmosphere; and
a number of LED light sources located in the chamber body. Each LED light source includes one LED and at least one of a focusing lens. One of the lenses can be part of a LED package.

In a second exemplary embodiment the technology described herein comprises:
an electrical control unit as in the first exemplary embodiment, additionally including a number of UV light sources as were located in the chamber in the first exemplary embodiment.;
an optical fiber light guide, one per light source, which transmits the UV power from the light source into the UV chamber (the optical fiber light guide can be comprised from a single fiber or a bundle of fibers); and
a UV curing chamber body as in the first exemplary embodiment, except that the wiring and light sources are replaced with the light emitting end of an optical fiber light guide (depending on the diameter of the fiber optical light guide, there can be additional focusing lenses to further increase UV intensity on the coated product surface).

In a third exemplary embodiment the technology disclosed herein comprises:
an electrical control unit as in the second exemplary embodiment, where the light sources can also include other practical sources other than LEDs, such as halogen light bulbs and LED arrays;
an optical fiber light guide bundle which transmits the UV power from the light source into UV chamber; and
a UV curing chamber body as in the second exemplary embodiment, where the optical fiber light guide is a branch of the optical fiber guide bundle (in this embodiment the single light source is either divided to cover multiple curing spots on the product or multiple light sources are combined to focus on the same curing spot for higher curing output, depending on the application requirement).

An aspect of the technology disclosed herein is that it uses UV LED's that are very efficient in producing the necessary UV power.

Another aspect of the technology disclosed herein is that it eliminates the need for separate reflectors (light emitting points are located in proximity to the fiber and the UV light is optically focused to a narrow beam, with the beam being slightly larger than the targeted coated fiber itself; the excess minor portion of the light beam could be reflected towards the backside of the coated fiber from a mirror polished wall, located very close (˜few mm or less) to the target fiber) or could be used to detect fiber position for alignment purpose (ref 0058).

Yet another aspect of the technology disclosed herein is that its compact design results in a lower operating cost due to it not generating excessive heat or ozone.

Still another aspect of the technology disclosed herein is that is does not require a high volume N2 flow through since it does not require additional quartz tubes or other protective tubes with the resultant high heat/IR component.

Another aspect of the technology described herein is that it provides a system that is economical.

There has thus been outlined, rather broadly, the features of the present invention in order that the detailed description that follows may be better understood, and in order that the present contribution to the art may be better appreciated. There are additional features of the invention that will be described and which will form the subject matter of the claims. Additional aspects and advantages of the present invention will be apparent from the following detailed description of an exemplary embodiment which is illustrated in the accompanying drawings. The invention is capable of other embodiments and of being practiced and carried out in various ways. Also, it is to be understood that the phraseology and terminology employed are for the purpose of description and should not be regarded as limiting.

### BRIEF DESCRIPTION OF THE DRAWINGS

The technology described herein will be better understood by reading the detailed description of the invention with reference to the accompanying drawing figures, in which like reference numerals denote similar structure and refer to like elements throughout, and in which:

FIG. 1 illustrates six exemplary embodiments of the technology described herein;

FIG. 2 illustrates a configuration for a UV curing chamber, according to an embodiment of the technology described herein;

FIG. 3 illustrates a configuration for a visual alignment method, according to an embodiment of the technology described herein;

FIG. 4 illustrates a configuration for a non-visual alignment method, according to an embodiment of the technology described herein;

FIG. 5 illustrates a configuration for a UV and non-UV arrangement, according to an embodiment of the technology described herein; and

FIG. 6 illustrates a configuration for increased tolerance method, according to an embodiment of the technology described herein.

### DETAILED DESCRIPTION OF THE INVENTION

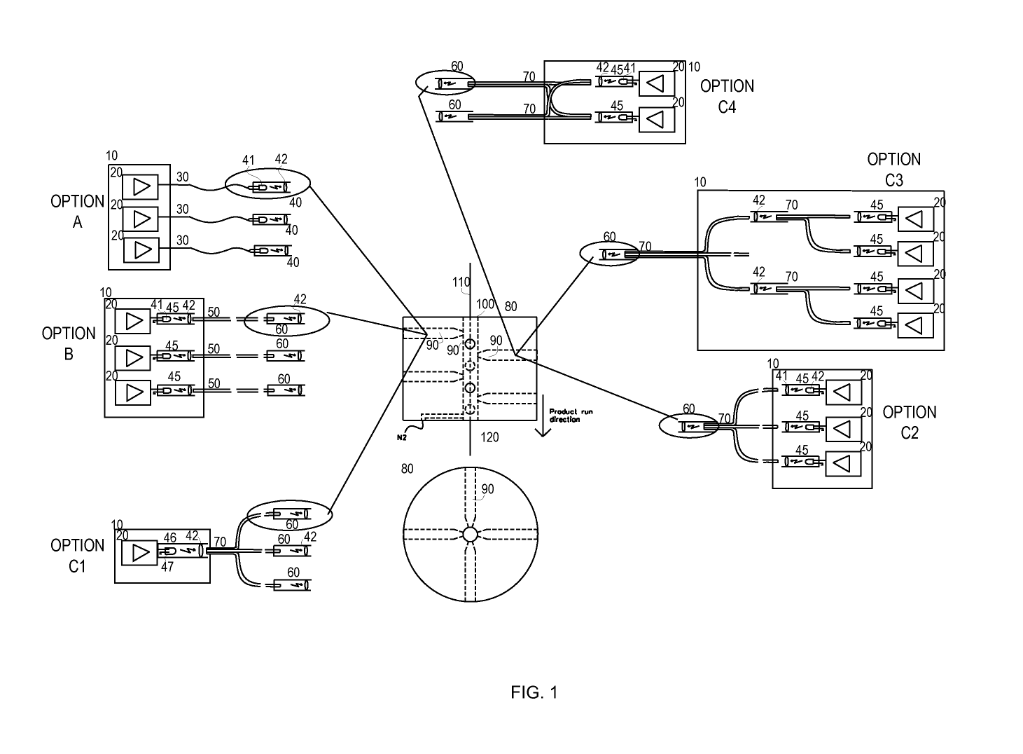

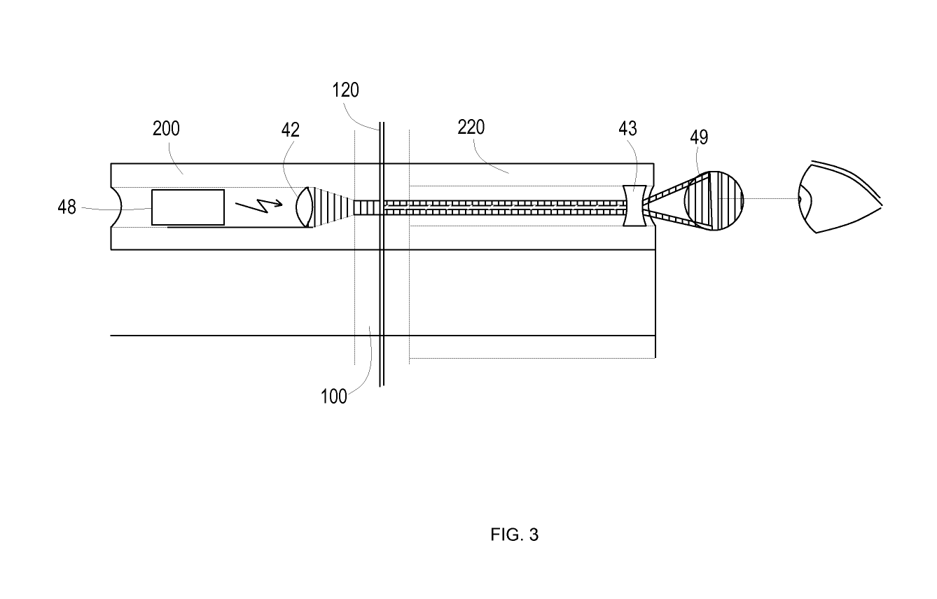

In describing the preferred and other embodiments of the technology described herein, as illustrated in FIGS. 1-6, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-7, illustrated therein is a device, method and system for providing a system, method and devices for an improved way to harden UV-curable coating materials that have been applied to optical fibers.

FIG. 1 option A illustrates a configuration for a UV curing chamber, according to the first exemplary embodiment of the technology;

In the option A embodiment the technology described herein comprises:
an electrical control unit (10) that feeds electrical power to light sources; conducts on/off control; regulates output power; monitors operation etc.;
a UV curing chamber body (80) which is connected to the electrical control unit through signal and power wiring (30); the chamber body provides an open path for the product run through (100) as well as housing (90) for number of LED light source heads (40) that are arranged to provide even curing around the product (110); the chamber body has also ports and controls for an N2 atmosphere; and
a number of LED light source heads (40) located in the chamber body. Each LED light source head includes one LED light source (41) and at least one of a focusing lens (42). One of the lenses can be part of a LED package.

FIG. 1 option B illustrates a configuration for a UV curing chamber, according to the second exemplary embodiment of the technology;

In the option B embodiment, the technology described herein comprises:
an electrical control unit (10) as in the first exemplary embodiment, additionally including a number of UV light sources (45) as were located in the chamber in the first exemplary embodiment.;
an optical fiber light guide (50), one per light source, which transmits the UV power from the light source into the UV chamber (80) (the optical fiber light guide can be comprised from a single fiber or a bundle of fibers); and
a UV curing chamber body (80) as in the first exemplary embodiment, except that the wiring and light sources are replaced with the light emitting end (60) of an optical fiber light guide (depending on the diameter of the fiber optical light guide, there can be additional focusing lenses to further increase UV intensity on the coated product surface).

FIG. 1 option C (which encompasses Options C1, C2, C3 and C4) illustrates a configuration for a UV curing chamber, according to the third exemplary embodiment of the technology;

In the option C embodiment the technology described herein comprises:
an electrical control unit (10) as in the second exemplary embodiment, where the UV light sources (46) can also include other practical light producing media other than LEDs (41), such as halogen light bulbs and LED arrays;
an optical fiber light guide bundle (70) which transmits the UV power from the light source into UV chamber; and
a UV curing chamber body (80) as in the second exemplary embodiment, where the optical fiber light guide head (60) is a branch of the optical fiber guide bundle (70) (in this embodiment the output of the single light source (46) is either divided to cover multiple curing spots on the product or multiple light sources are combined to focus on the same curing spot for higher curing output, depending on the application requirement).

Referring now to FIG. 1, option C1 divides a single light source output in order to multiple curing spots. Options C2 and C3 are both adding output power by providing multiple light source outputs to a single curing spot. This design provides a more compact curing chamber design since fewer curing spots are required. Options C2 and C3 also facilitates the option to operate LEDs in pulsating mode to produce more peak power than with continuous mode by timing LED ON-cycles so that while some LEDs in same curing spot are OFF some are ON, ensuring continuous UV flux. The difference between option C2 and C3 is that in the latter multiple light sources can be connected to single light guide strand of light guide head.

In the C4 option, the effects of C1 and C3 option are combined. In this arrangement all connected curing spots will always get same output even if one light source fails. This design is easier to use when multiple wave lengths are required for curing spots.

The technology described herein comprises an electrical control unit, a UV curing chamber and a source of UV power.

The technology described herein, in all three of the embodiments described above, requires an electrical control unit (10) and a UV curing chamber (80).

Characteristics of the electrical control unit (10) include, but are not limited to:
being configured to convert AC power to DC power suitable for the control logic and light sources
being configured to include the following functional elements:
   driver circuits (20) for light sources (40,45 or 46) to regulate and monitor output power of light sources, where power levels can be fixed or variable;
   an interface for an operator and/or a remote master control system to operate and monitor the system; and
   optional safety interlock features to prevent accidental direct eye contact with UV light.

In the first exemplary embodiment, all the driver circuit outputs are connected to light sources via control wiring (30), but in the second and third exemplary embodiments other methods, e.g. direct mount on circuit board, etc., are applied.

Characteristics of the UV curing chamber, include, but are not limited to:
The UV curing chamber (80) is a mechanical body, which, in order to simplify its manufacturing, can be made of multiple elements that are similar to each other.
For a one piece UV curing chamber:
   to form the body, use a round metal rod length of at least “a”-factor X number of light spots;
   drill a small diameter through hole in the center of a round cross section of the rod;
   for each light emitting point drill first a small diameter hole, large enough to pass a light beam without interruptions, toward the above center line and then increase the diameter to accommodate necessary light emitting parts (depending on configuration option in question);
   in order to utilize chamber walls to catch and reflect runaway UV rays back to the product surface and to avoid UV power travelling backward toward light source, there are no more than one light emitting point in any directional location on the product path.

The indicia used in the Figures are described in the following chart:

| Indicia | Description |
|---|---|
| 10 | Boundary of the Electrical Control Unit |
| 20 | Light source driver/control circuit (LED driver) |
| 30 | Electrical wiring used in option A |
| 40 | Light source head (housing the light producing media |
| | (UV-LED) and Lens) |
| 41 | LED |
| 42 | Focusing Lens |
| 43 | Spreading Lens |
| 45 | UV-Light source located in boundary of electrical control |
| | unit including UV-Led and at least one focusing lens. |
| | The lens can be part of LED package |
| 46 | UV-Light source (as 45 but, which can also include other |
| | light producing media than single LED) |
| 47 | UV light producing media which can be other than single LED |
| 48 | Non UV light source or Non UV light source Head |
| 49 | Visual Detection Resultant |
| 50 | Fiber optic light guide |
| 60 | Light guide head (housing optical fiber or fiber bundle end |
| | and optional lens) |
| 70 | Fiber optic light guide bundle |
| 80 | UV Curing Chamber |
| 90 | Housing either for Light Guide Head (60) or Light Source |
| | Head (40) |
| 100 | Product Pass thru hole |
| 110 | Coated fiber (wet coating) |
| 120 | Coated fiber (cured coating) |
| 130 | Coater Die |
| 140 | Optical Sensor, CCD sensor or Linear Photodiode array |
| | for instance |

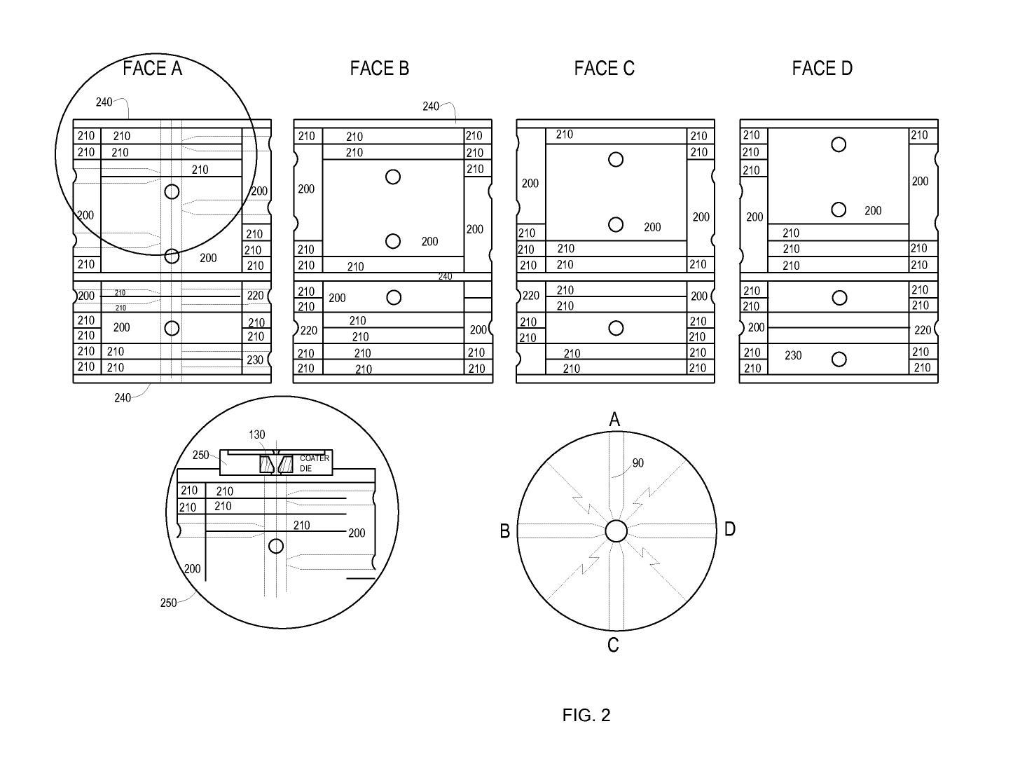

In order to lower manufacturing cost of the UV Curing Chamber and to make it easier to construct systems with different quantity of light sources and different kind of optional features, the UV Curing Chamber 80 may be designed to be made of multiple segments that cover 360 degree area around the product and are connected together with self-aligning method such as tongue-groove or wrap around band. There can be different kind of segmented pieces that all have the same cross-sectional outside shape, but can vary by length and inside construction:
Housing (200):Housing for one or more light source heads (40) or light guide heads (60) (depending on the embodiment) where number of cells are spaced according to a certain distance (number of light source axes times indexing offset between them);
Dummy Segments (210): Dummy segments to offset location light source locations of the above housing of the axis in question from the ones in other axes.
Alignment Segments (220): Alignment segments, which are to house different position sensing options all to ensure that product path (110) is properly aligned in the pass thru hole 100.
Nitrogen Segments (230): Segments for Nitrogen supply, control and optional oxygen monitoring ports. For more complex systems, nitrogen supply and exhaust (if needed) can be arranged anywhere in the product path.
Lid Plate (240): Additionally the UV chamber can have lid plates on both entry and exit side of assembly. In the minimum, these lids help to keep segmented pieces together, but they can also be used as mounting adapters to connect chamber with the coloring system with or without adjustable XY-table or to tie additional UV chambers together for higher curing power.
Entry Lid (250) housing the coating die (FIG. 2, detail): The entry lid can also be made so that it would provide housing for coating die system (130) so that no alignment is needed between the die and curing chamber.

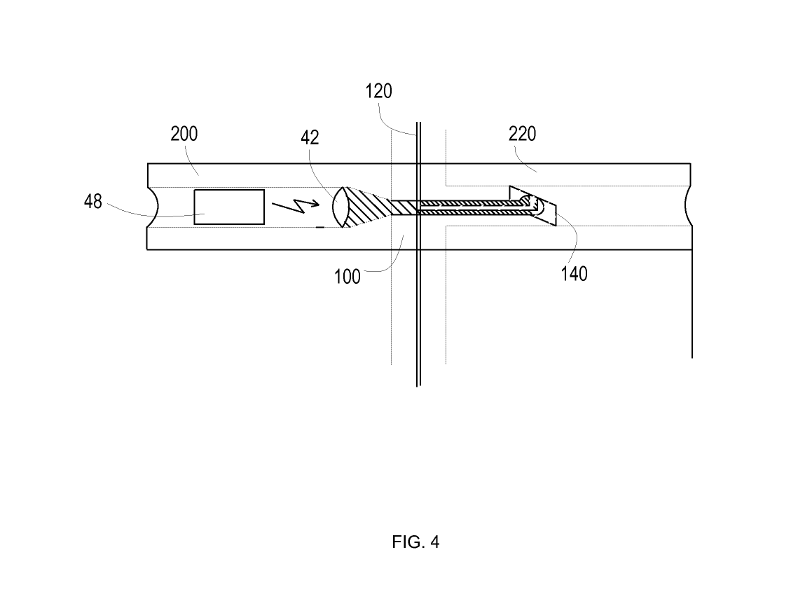

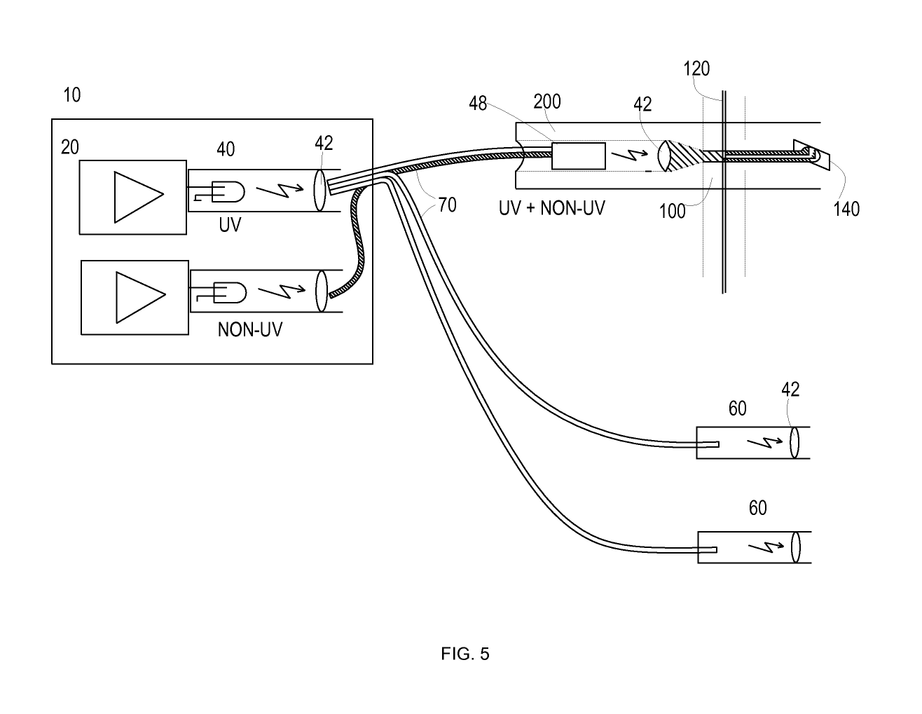

In order to ensure accurate alignment between the product (110) and curing chamber (80) different alignment sensing and control methods can be used, as described below:
Visual Method (FIG. 2): In the visual method, there is at least one, but preferably at least two, additional light source heads (or light guide heads) (48), preferably in 90 degree angle to each, providing visible light to human eye instead of UV light:
   exactly on the opposite side, there is an alignment segment (220) which would pass this light outside through a different kind of media (sight glass, video inspection camera, fiber endoscope or projection on the surface) (49);
   the visible light can be introduced into curing chamber in similar ways as UV light is introduced in the three exemplary embodiments described above;
   the unifying element of all them is that, when the visible light comes from behind the product (120), it is spread so that an operator can see the product as a dark line (shadow) in the center of a round light object when the alignment is optimum; and
Non-Visual Method FIG. 4: in the non-visual (automatic) method the method is the same as the visual method but instead of passing the light out, there is an optical sensor, e.g., CCD (Charge Coupled Device) sensor or Linear Photo Diode array sensor, used to locate the position of the shadow of the product:
   the wavelength (source) of the light can be the same as for curing (UV) and in this case the excess UV radiation passing product is used for alignment purpose or it can be from different source (not necessarily visible to eye;
   if other than UV wavelength used for curing is used for sensing, then it can be introduced into curing chamber in similar ways as UV light is introduced in the three exemplary embodiments described above;
   the output of the sensors can be used for automatic centering with a motorized XY-table.
Branched Fiber Bundle, FIG. 5, can be used as Light Guide (as in the third exemplary embodiment), and if other wavelength than UV for curing is used for position sensing, then some of the bundled fibers can be used to carry the wavelength used for the alignment sensing (either for visual or non-visual method as described above); in this arrangement the alignment sensor would be located exactly on the opposite side of the fiber bundle end; Even if non-UV wavelength is used for alignment sensing, the sensing could be done, as shown in the picture, on the curing spot by mixing fiber bundle strands from two wave length sources in the light guide head.

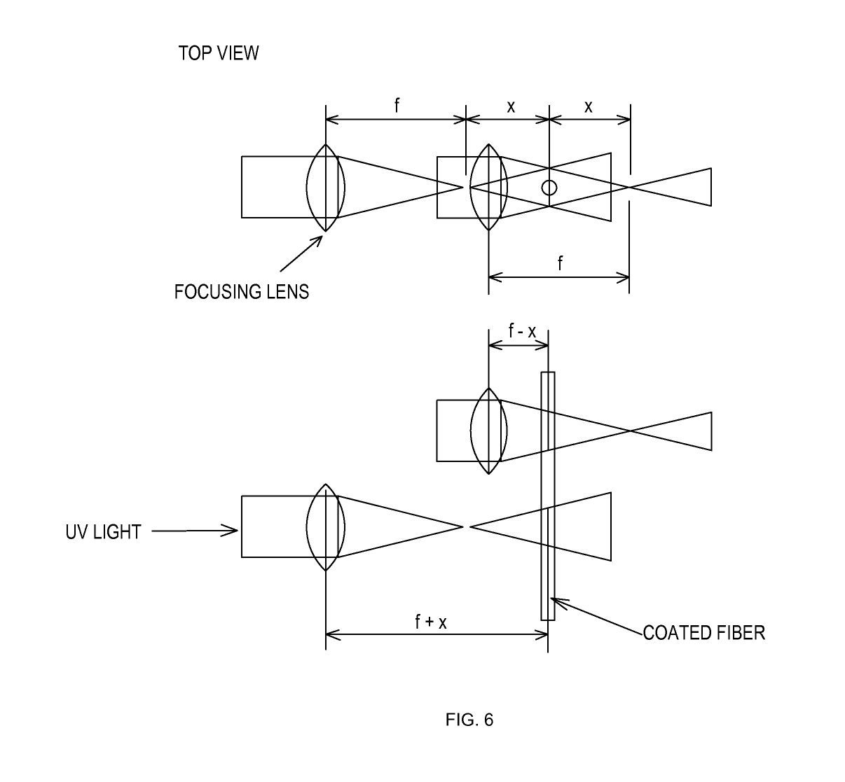

Increased Alignment Tolerance, FIG. 6: In order to allow some movement of product from its optimal path (due to initial miss alignment, vibration due to tension variations in process or guide pulley wobble), UV light source heads (40) (or UV light guide heads (60)) with same focal lengths may symmetrically be aligned on same axis along the product path off from products surface:
for each curing point with focal point x mm before the product path line, there should be a curing point on the same axis with focal point x mm behind the product path line; and
if the product moves in the direction of the axis, in one curing point light intensity increases and in another decreases on the surface of product resulting to a fact that total amount of light received by the surface would remain same or increase within a range +/- x mm around the product path.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the disclosed technology and are intended to be covered by the following claims.

What is claimed is:

1. A system for UV curing, comprising:
a. an electrical control unit;
b. a UV curing chamber operably connected to the electrical control unit; and
c. at least one LED light source head disposed within the UV curing chamber.

2. The system for UV curing of claim 1, further comprising:
a. the UV curing chamber configured for connecting to the electrical control unit by wiring;
b. the at least one LED light source head configured for an LED light source and at least one of a focusing lens;
c. the electrical control unit configured for feeding light sources input power to the at least one LED light source head; and
d. the UV curing chamber configured for providing an open path for a product having a coated surface disposed thereon run through, for housing a plurality of LED light source heads arranged in an array, and for providing even curing around the product.

3. The system for UV curing of claim 2, further comprising:
a. the electrical control unit including comprising:
i. at least one light sources driver circuit configured for regulating and monitoring the light sources output power;
ii. an operator interface configured for operating and monitoring the system; and
iii. a power assembly configured for providing power for controls and for the LED light sources.

4. The system for UV curing of claim 3, further comprising:
a. a safety interlock assembly configured for preventing accidental direct eye contact with UV light, and
b. the UV curing chamber further configured for controlling an N2 atmosphere.

5. A system for UV curing, comprising:
a. an electrical control unit;
b. a UV curing chamber operably connected to the electrical control unit; and
c. at least one light guide head disposed within the UV curing chamber.

6. The system for UV curing of claim 5, further comprising:
a. the at least one light guide head configured for an LED light source and at least one of a focusing lens;
b. the electrical control unit further comprising a plurality of UV light sources and configured for feeding electrical power to the at least one LED light source;
c. an optical fiber light guide for each UV light source, the optical fiber light guide configured for transmitting UV light from each UV light source in the UV chamber;
d. the UV curing chamber configured for connecting to the electrical control unit by an optical fiber light guide having a light absorbing end operably connected to the electrical control unit; and
e. the UV curing chamber configured for providing an open path for a product having a coated surface disposed thereon run through, for housing a plurality of light guide heads arranged in an array, and for providing even curing around the product.

7. The system for UV curing of claim 6, wherein the optical fiber light guide is comprised of a single fiber.

8. The system for UV curing of claim 6, wherein the optical fiber light guide is comprised of a bundle of fibers.

9. The system for UV curing of claim 7, wherein the UV curing chamber body is further comprised of at least one additional focusing lens configured for increasing UV intensity on the coated product surface.

10. The system for UV curing of claim 8, wherein the UV curing chamber body is further comprised of at least one additional focusing lens configured for increasing UV intensity on the coated product surface.

11. The system for UV curing of claim 6, further comprising:
a. the electrical control unit including
i. a plurality of light sources driver circuits configured for regulating and monitoring light sources output power;
ii. an operator interface configured for operating and monitoring the system; and
iii. a power assembly configured for providing power for controls and for the LED light sources.

12. The system for UV curing of claim 11, further comprising a safety interlock assembly configured for preventing accidental direct eye contact with UV light.

13. The system for UV curing of claim 11, wherein the optical fiber light guide is comprised of a single fiber.

14. The system for UV curing of claim 11, wherein the optical fiber light guide is comprised of a bundle of fibers.

15. The system for UV curing of claim 13, wherein the UV curing chamber body is further comprised of at least one additional focusing lens configured for increasing UV intensity on the coated product surface.

16. The system for UV curing of claim 14, wherein the UV curing chamber body is further comprised of at least one additional focusing lens configured for increasing UV intensity on the coated product surface.

17. The system for UV curing of claim 5, further comprising:
a. the at least one LED light guide head configured for an LED light source and at least one of a focusing lens;
b. the electrical control unit further comprising a plurality of UV light sources and configured for feeding electrical power to the at least one LED light source;
c. an optical fiber light guide bundle configured for transmitting UV light into the UV chamber from light sources in the electrical control unit; and
d. the UV curing chamber configured for providing an open path for a product having a coated surface disposed thereon run through, for housing a plurality of LED light guide heads arranged in an array, for providing even curing around the product.

18. The system for UV curing of claim 17, further comprising:
a. the UV curing chamber configured for connecting to the electrical control unit by an optical fiber light guide bundle having a light emitting end operably connected to the electrical control unit, the optical fiber light guide head comprising a branch from at least one optical fiber light guide bundle.

19. The system for UV curing of claim 17, further comprising:
a. the UV curing chamber configured for connecting to the electrical control unit by an optical fiber light guide bundle having a light emitting end operable connected to at least one light source and the at least one light sources operably connected to at least one guide bundle in the electrical control unit.

20. The system for UV curing of claims 2 and 6, the product further comprising an optical fiber or an arrangement of multiple coated optical fibers.
